(19) United States
(12) Patent Application Publication
(10) Pub. No.: US 2017/0088136 A1
(43) Pub. Date: Mar. 30, 2017

(54) APPARATUS AND METHOD OF CONTROLLING AUTOMATIC DRIVING OF VEHICLE

(71) Applicant: HYUNDAI MOBIS Co.,Ltd., Yongin-si (KR)

(72) Inventors: Kyung Il SEO, Yongin-si (KR); Moo Youl JO, Yongin-si (KR)

(73) Assignee: HYUNDAI MOBIS Co.,Ltd., Yongin-si (KR)

(21) Appl. No.: 15/266,499

(22) Filed: Sep. 15, 2016

(30) Foreign Application Priority Data
Sep. 24, 2015 (KR) 10-2015-0135808

(51) Int. Cl. B60W 30/16

(52) U.S. Cl. CPC B60W 30/16; B60W 2750/30

(57) ABSTRACT

An apparatus for controlling automatic driving of a vehicle includes a vehicle sensing unit configured to sense a leading vehicle or other nearby vehicle and sense a speed and a relative distance of a leading vehicle or other nearby vehicle from the vehicle, a target acceleration calculation unit configured to calculate a danger level indicating an influence on driving of the vehicle of the leading vehicle or the nearby vehicle using the sensed speed and relative distance and calculate a target acceleration of the vehicle according to the danger level, and a vehicle control unit configured to control the vehicle to drive at an automatic driving speed and control the vehicle according to the target acceleration upon sensing the leading vehicle or the nearby vehicle.

### CROSS-REFERENCE TO RELATED APPLICATION

This application claims priority to and the benefit of Korean Patent Application No. 10-2015-0135808, filed on Sep. 24, 2015 in the Korean Intellectual Property Office, the disclosure of which is incorporated herein by reference.

### BACKGROUND

1. Field

The present disclosure relates to an apparatus and method of controlling automatic driving of a vehicle in performing a cruise control function of the vehicle for controlling the vehicle to drive at an automatically set speed.

2. Description of the Related Art

Recently, technology for automatically driving a vehicle without manipulation of a driver has been developed.

An automatic driving technology of a vehicle is called smart cruise control (SCC) and is the basis of a driver assistance system (DAS) in which cruise control is performed when there is no leading vehicle and distance control is performed when a vehicle enters a lane of the vehicle by adding a vehicle environment sensor (e.g., radar, camera, etc.) to a typical cruise control system.

### SUMMARY

The present disclosure relates to an apparatus and method of controlling automatic driving of a vehicle and, more particularly, to an apparatus and method of controlling automatic driving of a vehicle, for preventing collision by determining a dangerous situation caused by a nearby vehicle as well as a leading vehicle and controlling acceleration of the vehicle by reflecting a traffic flow around the vehicle, in performing a cruise control function of the vehicle for controlling the vehicle to drive at an automatically set speed.

It is an aspect of the present invention to provide an apparatus and method of controlling automatic driving of a vehicle, for preventing collision and thus improving safety of the vehicle by recognizing a sudden stop possibility of a leading vehicle or an interception possibility of a nearby vehicle during automatic driving of the vehicle.

It is another aspect of the present invention to provide an apparatus and method of controlling automatic driving of a vehicle, for improving ride comfort by controlling deceleration as well as acceleration during automatic driving of the vehicle.

The aspects of the present invention are not limited to what has been particularly described hereinabove and other aspects not described herein will be more clearly understood by persons skilled in the art from the following detailed description.

An aspect of the present invention provides an apparatus for controlling automatic driving of a vehicle, including a vehicle sensing unit configured to sense a leading vehicle driving in front of the vehicle in a driving lane of the vehicle or a nearby vehicle driving in a left or right lane of the driving lane of the vehicle and sense a speed of the leading vehicle and a relative distance from the vehicle to the leading vehicle or a speed of the nearby vehicle and a relative distance from the vehicle to the nearby vehicle, a target acceleration calculation unit configured to calculate a danger level indicating an influence on driving of the vehicle of the leading vehicle or the nearby vehicle using the sensed speed and relative distance and calculate a target acceleration of the vehicle according to the danger level, and a vehicle control unit configured to control the vehicle to drive at an automatic driving speed and control the vehicle according to the target acceleration upon sensing the leading vehicle or the nearby vehicle.

Another aspect of the present invention provides a method of controlling automatic driving a vehicle, including performing constant speed driving for controlling driving of the vehicle at an automatic driving speed, performing vehicle sensing for sensing a leading vehicle driving in front of the vehicle in a driving lane of the vehicle or a nearby vehicle driving at a right or left lane of the driving lane of the vehicle and sensing a speed of the leading vehicle and a relative distance from the vehicle to the leading vehicle or a speed of the nearby vehicle and a relative distance from the vehicle to the nearby vehicle, performing target acceleration calculation for calculating a danger level indicating an influence on driving of the vehicle by the leading vehicle or the nearby vehicle using the sensed speed and relative distance and calculating a target acceleration of the vehicle in correspondence to the danger level, and performing vehicle control for controlling the vehicle according to target acceleration upon sensing the leading vehicle or the nearby vehicle.

A further aspect of the invention provides a method of cruise control of a vehicle, the method comprises detecting nearby vehicles comprising at least one vehicle driving ahead or behind of the vehicle on the same lane, the right lane and the left lane; acquiring data for each nearby vehicle indicative of a distance to the nearby vehicle, a speed of the nearby vehicle, acceleration of the nearby vehicle and jerk of the nearby vehicle; assessing probability of accidents with each nearby vehicle; identifying the most risky one of the nearby vehicles; computing a range of acceleration that the vehicle can have while driving under cruise control in view of the acquired data for the nearby vehicles; and determining an acceleration value within the range while driving under cruise control in view of the distance to and speed of the most risky nearby vehicle. The foregoing method may further comprises: identifying the second most risky nearby vehicle among the nearby vehicles; and determining the acceleration value within the range in view of the distance to and speed of the most risky nearby vehicle and further in view of the distance and speed of the second most risky nearby vehicle.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of the configuration of an apparatus for controlling automatic driving of a vehicle according to an embodiment of the present invention;

FIG. 2 illustrates a situation in which a vehicle sensing unit senses a leading vehicle or a nearby vehicle according to an embodiment of the present invention;

FIG. 3 is a graph illustrating the distribution of a danger level of a nearby vehicle calculated by the nearby vehicle danger level calculation unit according to an embodiment of the present invention;

FIG. 4 is a graph illustrating an acceleration and jerk band calculated by a band calculation unit 220 of the apparatus for controlling automatic driving of a vehicle according to an embodiment of the present invention;

FIG. 5 is a flowchart illustrating a method of controlling automatic driving of a vehicle according to embodiments of the present invention;

FIG. 6 is a flowchart illustrating target acceleration calculation upon sensing a leading vehicle as an embodiment of the method of controlling automatic driving of a vehicle according to embodiments of the present invention; and

FIG. 7 is a flowchart illustrating target acceleration calculation upon sensing a nearby vehicle as an embodiment of the method of controlling automatic driving of a vehicle according to embodiments of the present invention.

### DETAILED DESCRIPTION OF EMBODIMENTS

Advantages and features of the invention, and a method for achieving the invention will be apparent with reference to the accompanying drawings and embodiments disclosed in the following description. However, the present invention is not limited thereto or restricted thereby and may be embodied in diverse manners. The embodiments will be provided so that those skilled in the art may clearly understand the scope of the invention. The invention is defined by the claims and their equivalents. Like reference numerals refer to like elements throughout.

A typical cruise control technology may cause a driver to feel discomfort or displeasure by randomly changing a speed set by the driver regardless of driver intention, does not fulfill improvement of ride comfort during braking generated when a vehicle decelerates by simply controlling only acceleration, and prepares for only a dangerous situation caused by a leading vehicle.

Hereinafter, an apparatus and method of controlling automatic driving of a vehicle according to embodiments of the present invention will be described with reference to the attached drawings.

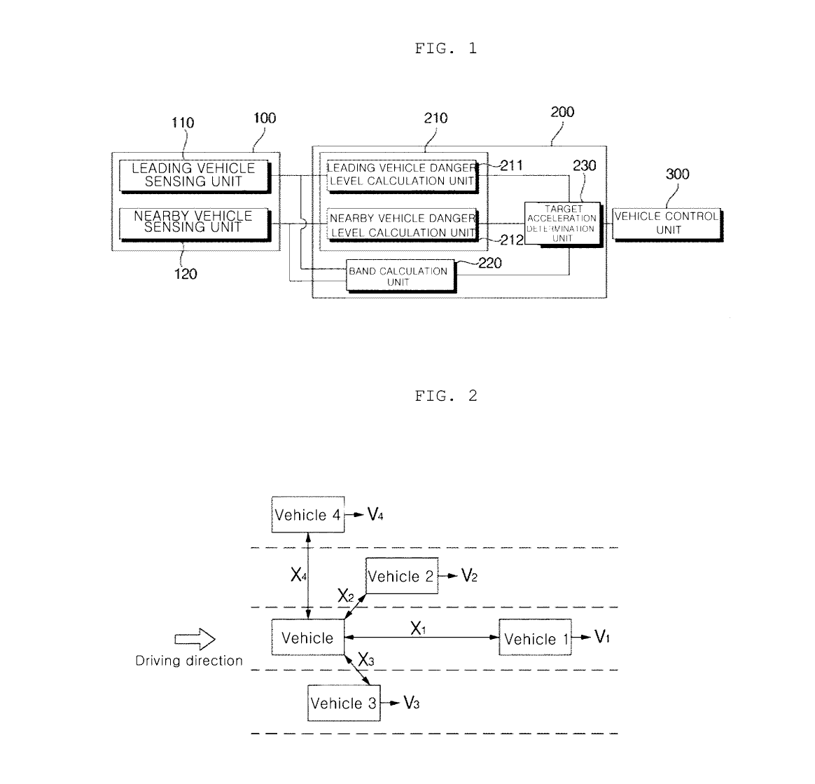

FIG. 1 is a block diagram of the configuration of an apparatus for controlling automatic driving of a vehicle according to an embodiment of the present invention.

The apparatus for controlling automatic driving of a vehicle according to embodiments of the present invention includes a vehicle sensing unit 100, a target acceleration calculation unit 200, and a vehicle control unit 300. The vehicle sensing unit 100 includes a leading vehicle sensing unit 110 and a nearby vehicle sensing unit 120. The target acceleration calculation unit 200 includes a danger level calculation unit 210, a band calculation unit 220, and a target acceleration determination unit 230. The danger level calculation unit 210 includes a leading vehicle danger level calculation unit 211 and a nearby vehicle danger level calculation unit 212.

Specifically, the apparatus for controlling automatic driving of a vehicle according to embodiments of the present invention includes the vehicle sensing unit 100 for sensing a leading vehicle driving in front of the vehicle in a driving lane of the vehicle or a nearby vehicle driving at a left or right lane of the driving lane of the vehicle and sensing a speed of the leading vehicle and a relative distance from the vehicle to the leading vehicle or a speed of the nearby vehicle and a relative distance from the vehicle to the nearby vehicle, the target acceleration calculation unit 200 for calculating a danger level indicating an influence on driving of the vehicle by the leading vehicle or the nearby vehicle using the sensed speed and relative distance and calculating a target acceleration of the vehicle according to the danger level, and the vehicle control unit 300 for controlling the vehicle to drive at an automatic driving speed corresponding to a speed input by a driver and controlling the vehicle according to the target acceleration upon sensing the leading vehicle or the nearby vehicle.

The vehicle sensing unit 100 senses the speed of the leading vehicle or the nearby vehicle and the relative distance between the vehicle and the leading vehicle or the nearby vehicle. To this end, the vehicle sensing unit 100 includes at least one of a camera, a distance measurement sensor, and a speed measurement sensor. The vehicle sensing unit 100 is sufficient as a means capable of measuring a distance and a speed and is not particularly limited.

The vehicle sensing unit 100 is arranged at the front side and both sides of the vehicle. Alternatively, the vehicle sensing unit 100 may be arranged only at the front side of the vehicle. The arranged location of the vehicle sensing unit 100 is sufficient as a location capable of sensing the leading vehicle or the nearby vehicle and is not particularly limited.

The vehicle sensing unit 100 includes the leading vehicle sensing unit 110 for sensing the speed and the relative distance with respect to the leading vehicle and the nearby vehicle sensing unit 120 for sensing the speed and the relative distance with respect to the nearby vehicle.

The leading vehicle sensing unit 110 is arranged at the front side of the vehicle and senses the speed of the leading vehicle and the relative distance between the vehicle and the leading vehicle. The nearby vehicle sensing unit 120 is arranged at both sides of the vehicle and senses the speed of the nearby vehicle and the relative distance between the vehicle and the nearby vehicle.

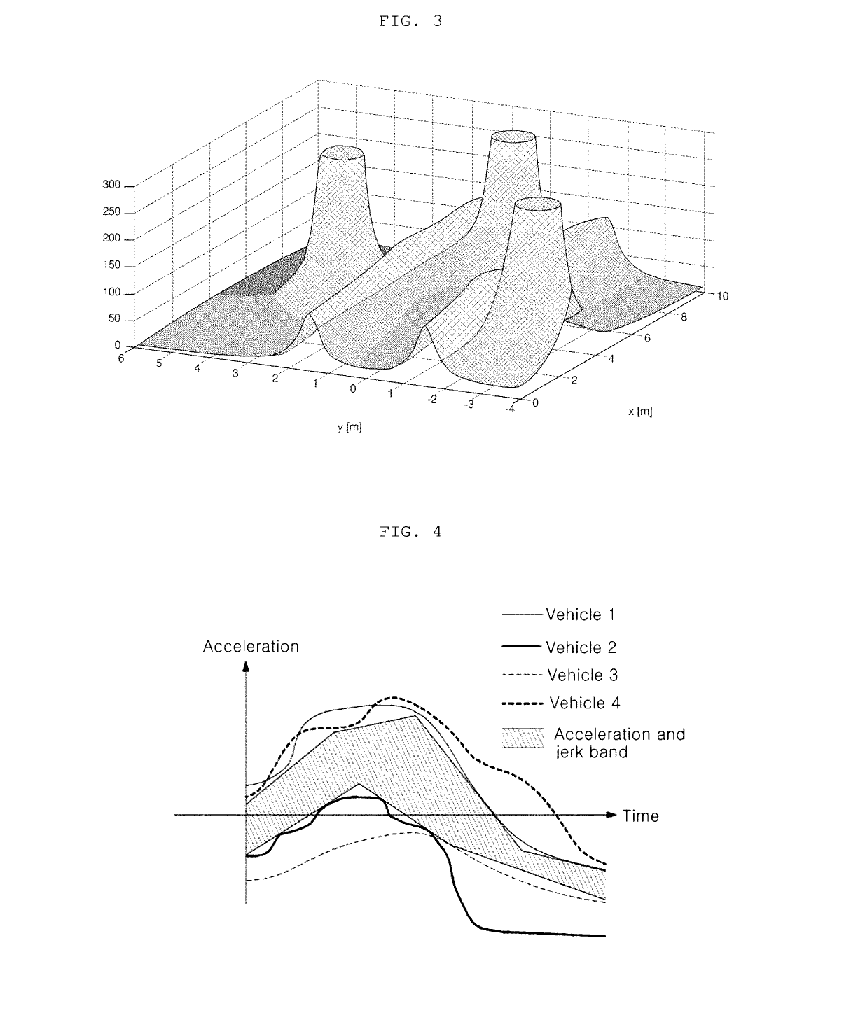

FIG. 2 illustrates a situation in which the vehicle sensing unit 100 senses a leading vehicle or a nearby vehicle according to an embodiment of the present invention.

According to this embodiment, vehicle 1 corresponds to a leading vehicle and vehicle 2 to vehicle 4 correspond to nearby vehicles. Only one leading vehicle is present but more than one nearby vehicle is present. The leading vehicle sensing unit 110 measures a speed V₁ of vehicle 1 and a relative distance X₁ between a vehicle and vehicle 1. The nearby vehicle sensing unit 120 measures a speed V₂ of vehicle 2, a relative distance X₂ between the vehicle and vehicle 2, a speed V₃ of vehicle 3, a relative distance X₃ between the vehicle and vehicle 3, a speed V₄ of vehicle 4, and a relative distance X₄ between the vehicle and to vehicle 4.

The leading vehicle sensing unit 110 transmits the sensed speed and the relative distance with respect to the leading vehicle to the leading vehicle to the leading vehicle danger level calculation unit 211 and the band calculation unit 220. The nearby vehicle sensing unit 120 transmits the sensed speed and the relative distance with respect to the nearby vehicle to the nearby vehicle danger level calculation unit 212 and the band calculation unit 220.

The target acceleration calculation unit 200 calculates a target acceleration which is an acceleration that the vehicle desires to reach. When the vehicle drives at the target acceleration, ride comfort and safety are improved.

Upon receiving the sensed speed and the relative distance in relation to the leading vehicle and the nearby vehicle from the vehicle sensing unit 100, the target acceleration calculation unit 200 calculates a danger level indicating an influence on driving of the vehicle by the leading vehicle or the nearby vehicle and calculates the target acceleration of the vehicle corresponding to the danger level.

The target acceleration calculation unit 200 includes the danger level calculation unit 210 for calculating the danger level indicating an influence on driving of the vehicle by the leading vehicle or the nearby vehicle using the speed and the relative distance with respect to the leading vehicle or the nearby vehicle, the band calculation unit 220 for calculating an acceleration and a jerk (an instantaneous rate of change of the acceleration) of the leading vehicle or the nearby vehicle using the speed and the relative distance with respect to the leading vehicle or the nearby vehicle and calculating an acceleration and jerk band indicating a range within which the target acceleration is selected according to the calculated acceleration and the calculated jerk, and the target acceleration determination unit 230 for determining the target acceleration within the band according to the danger level of the leading vehicle or the nearby vehicle.

The danger level calculation unit 210 calculates the danger level of the leading vehicle indicating an influence on driving of the vehicle by the leading vehicle using the speed and the relative distance with respect to the leading vehicle and calculates the danger level of the nearby vehicle indicating an influence on driving of the vehicle by the nearby vehicle using the speed and the relative distance with respect to the nearby vehicle. If plural nearby vehicles are present, the danger level calculation unit 210 calculates respective danger levels of the nearby vehicles.

The danger level calculation unit 210 includes the leading vehicle danger level calculation unit 211 for calculating an expected time to collision (TTC) using the speed of the vehicle, the speed of the leading vehicle, and the relative distance between the vehicle and the leading vehicle, determining an expected acceleration of the leading vehicle by recognizing a speed variation pattern of the leading vehicle, and calculating the danger level of the leading vehicle by adding a value obtained by multiplying a first weight by the expected acceleration to a value obtained by multiplying a second weight by the TTC, and the nearby vehicle danger level calculation unit 212 for calculating a speed at which the nearby vehicle approaches the driving lane of the vehicle using the speed and the relative distance with respect to the nearby vehicle, a speed at which the nearby vehicle approaches the vehicle, and a distance between the nearby vehicle and the driving lane of the vehicle, calculating a possibility of intercepting the driving lane of the vehicle by the nearby vehicle according to the calculated speeds and the calculated distance, and calculating the danger level of the nearby vehicle corresponding to the interception possibility.

The danger level of the leading vehicle indicates an influence on driving of the vehicle by the leading vehicle and means a sudden stop possibility of the leading vehicle. The sudden stop possibility of the leading vehicle depends largely on the acceleration rather than the speed of the leading vehicle. In embodiments, as deceleration of the leading vehicle increases, a difference in speed between the vehicle and the leading vehicle increases and, as the difference in speed between the vehicle and the leading vehicle increases, a possibility that the leading vehicle suddenly stops increases. The danger level is adjusted in real time according to driver tendency or road traffic situation.

To recognize the sudden stop possibility of the leading vehicle, the leading vehicle danger level calculation unit 211 receives the speed and the relative distance with respect to the leading vehicle, sensed by the leading vehicle sensing unit 110, and calculates an expected TTC using the speed and the relative distance with respect to the leading vehicle. The TTC is a value obtained by dividing the relative speed between the vehicle and the leading vehicle by the relative distance therebetween.

In addition, the leading vehicle danger level calculation unit 211 determines the expected acceleration of the leading vehicle by recognizing a speed variation pattern of the leading vehicle. The leading vehicle danger level calculation unit 211 may include a memory for storing speed values of the leading vehicle for a predetermined time period in order to recognize the speed variation pattern of the leading vehicle.

The leading vehicle danger level calculation unit 211 calculates the danger level of the leading vehicle by adding a value obtained by multiplying a first weight by the expected acceleration to a value obtained by multiplying a second weight by the TTC. This may be expressed as follows:

$$Risk = {w}_{1} \frac{\vert {a}_{pre} \vert}{{v}_{s}} + {w}_{2} * {TTC}^{- 1}$$

$$where {TTC}^{- 1} = \frac{{V}_{rel}}{{D}_{rel}}$$

(where Risk is a danger level of a leading vehicle, w₁ is a first weight, w₂ is a second weight, νₛ is a current speed of a vehicle, aₚᵣₑ is an expected acceleration of a leading vehicle, Vᵣₑₗ is a relative speed, and Dᵣₑₗ is a relative distance.)

The leading vehicle danger level calculation unit 211 transmits the calculated danger level of the leading vehicle to the target acceleration determination unit 230.

The danger level of the nearby vehicle indicates an influence on driving of the vehicle by the nearby vehicle and means a possibility of intercepting the driving lane of the vehicle by the nearby vehicle. The interception possibility may be calculated from a speed at which the nearby vehicle approaches the driving lane of the vehicle, a speed at which the nearby vehicle approaches the vehicle, and a distance between the nearby vehicle and the driving lane of the vehicle. As the speed at which the nearby vehicle approaches the driving lane of the vehicle or the speed at which the nearby vehicle approaches the vehicle increases, the interception possibility by the nearby vehicle increases.

According to the embodiment of FIG. 2 in which there are more than one the nearby vehicle, since three nearby vehicles of vehicle 2 to vehicle 4, are present, the vehicle sensing unit 100 senses speeds of the three nearby vehicles and relative distances between the vehicle and the three nearby vehicles and the nearby vehicle danger level calculation unit 212 calculates danger levels of the three nearby vehicles using the speeds and relative distances with respect to the three nearby vehicles. In this case, three danger levels are calculated.

The nearby vehicle danger level calculation unit 212 receives the speed and the relative distance with respect to the nearby vehicle from the nearby vehicle sensing unit 120 and calculates the speed at which the nearby vehicle approaches the driving lane of the vehicle, the speed at which the nearby vehicle approaches the vehicle, and the distance between the nearby vehicle and the driving lane of the vehicle, using the received speed and relative distance. The nearby vehicle danger level calculation unit 212 calculates the interception possibility of the nearby vehicle which is proportional to the speed at which the nearby vehicle approaches the driving lane of the vehicle or the speed at which the nearby vehicle approaches the vehicle and is inversely proportional to the distance between the nearby vehicle and the driving lane of the vehicle.

Alternatively, the nearby vehicle danger level calculation unit 212 may calculate any one of the speed at which the nearby vehicle approaches the driving lane of the vehicle, the speed at which the nearby vehicle approaches the vehicle, and the distance between the nearby vehicle and the driving lane of the vehicle and may calculate the interception possibility by the nearby vehicle according to one of the calculated speeds and distance.

The nearby vehicle danger level calculation unit 212 calculates the danger level of the nearby vehicle corresponding to the interception possibility by the nearby vehicle. According to the embodiment of FIG. 2, the danger levels of vehicle 2 to vehicle 4 are calculated.

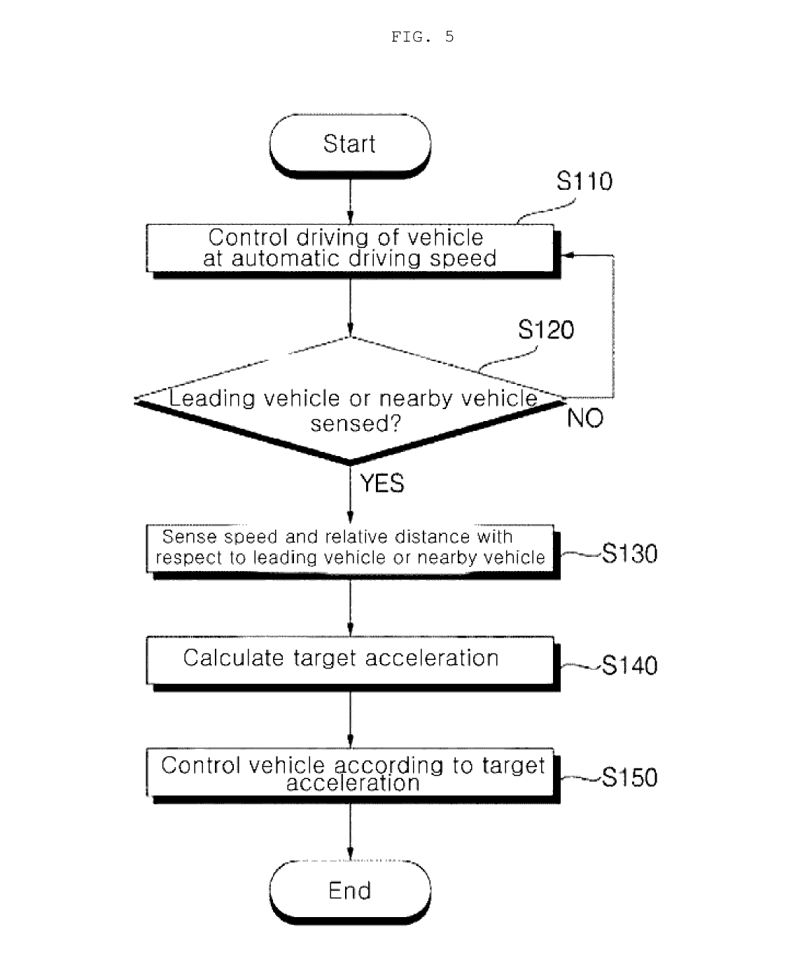

FIG. 3 is a graph illustrating the distribution of a danger level of a nearby vehicle calculated by the nearby vehicle danger level calculation unit 212 according to an embodiment of the present invention.

In the graph of FIG. 3, an X-axis and a Y-axis denote the location of a vehicle and a Z-axis denotes a danger level. A point at which the coordinate of the X-axis and the Y-axis is (0, 0) is the location of the vehicle.

The nearby vehicle danger level calculation unit 212 transmits the calculated danger level of the nearby vehicle to the target acceleration determination unit 230.

The band calculation unit 220 receives the speed and the relative distance with respect to the leading vehicle from the leading vehicle sensing unit 110 and receives the speed and the relative distance with respect to the nearby vehicle from the nearby vehicle sensing unit 120.

The band calculation unit 220 calculates an acceleration and a jerk (an instantaneous rate of change of the acceleration) of the leading vehicle or the nearby vehicle using the speed and the relative distance with respect to the leading vehicle or the nearby vehicle and calculates an acceleration and jerk band which is a range in which the target acceleration is selected according to the calculated acceleration and jerk.

FIG. 4 is a graph illustrating an acceleration and jerk band calculated by the band calculation unit 220 of the apparatus for controlling automatic driving of a vehicle according to an embodiment of the present invention.

Referring to FIG. 4, in a situation in which a plurality of vehicles drives around a vehicle, accelerations of the vehicles are illustrated, and an acceleration and jerk band including the accelerations of the vehicles is formed around the vehicle. The acceleration and jerk band indicates a range in which the target acceleration is selected. The acceleration of the leading vehicle and the accelerations of the nearby vehicles are illustrated in the graph of FIG. 4, so that a traffic flow around the vehicle can be confirmed. If the target acceleration of the vehicle is selected within a range in which the accelerations of the nearby vehicles are formed, safety of driving of the vehicle is improved. In embodiments, the accelerations of the vehicles around the vehicle are sensed and the accelerations of the vehicles around the vehicle are factored into the acceleration of the vehicle, thereby improving driving safety. Unlike FIG. 4, the acceleration and jerk band may be formed in a range including the accelerations of the vehicles around the vehicle.

The band calculation unit 220 transmits the acceleration and jerk band to the target acceleration determination unit 230.

The target acceleration determination unit 230 receives the danger level of the leading vehicle from the leading vehicle danger level calculation unit 211, receives the danger level of the nearby vehicle from the nearby vehicle danger level calculation unit 212, receives the acceleration and jerk band from the band calculation unit 220, and then determines the target acceleration within the acceleration and jerk band according to the danger level of the leading vehicle or the nearby vehicle.

The target acceleration determination unit 230 determines, as the target acceleration, an acceleration at which a relative distance between the leading vehicle or the nearby vehicle having a danger level equal to or greater than a setting value and the vehicle is equal to or greater than a first setting distance within the acceleration and jerk band. If there are plural nearby vehicles, danger levels are calculated with respect to the plural nearby vehicles and the danger levels are transmitted to the target acceleration determination unit 230. The target acceleration determination unit 230 determines, as the target acceleration, an acceleration at which a relative distance between a nearby vehicle having a preset value or more among the danger levels and the vehicle is equal to or greater than the first setting distance within the acceleration and jerk band.

The setting value indicates a state having a great influence on driving of the vehicle by the leading vehicle or the nearby vehicle, in embodiments, a highly dangerous state and may be randomly set by a user.

The first setting distance indicates a distance set to prevent collision between the vehicle and the leading vehicle or the nearby vehicle and may be randomly set by a user.

If the danger level of the leading vehicle is greater than the setting value, since this means that there is a high possibility that the leading vehicle suddenly stops, the first setting distance is set to a distance in which collision between the vehicle and the leading vehicle does not occur even when the leading vehicle suddenly stops.

If the danger level of the nearby vehicle is greater than the setting value, since this means that there is a high possibility that the nearby vehicle intercepts the driving lane of the vehicle, the first setting distance is set to a distance in which collision between the vehicle and the nearby vehicle does not occur even when the nearby vehicle intercepts the driving lane of the vehicle.

If the danger level of the leading vehicle is less than the setting value, the target acceleration determination unit 230 determines, as the target acceleration, an acceleration at which a relative distance between the leading vehicle and the vehicle is greater than a second setting distance within the acceleration and jerk band.

The second setting distance is a distance set to prevent collision between the vehicle and the leading vehicle and may be randomly set by a user. The second setting distance is different from the first setting distance which is set when the danger level of the leading vehicle or the nearby vehicle is greater than the setting value. However, values of the first and second setting distances may be equal.

If the danger level of the nearby vehicle is less than the setting value, the target acceleration determination unit 230 determines, as the target acceleration, an acceleration at which the vehicle drives at an automatic driving speed within the acceleration and jerk band. However, even in this case, if there is a leading vehicle in front of the driving lane of the vehicle, the target acceleration determination unit 230 determines the target acceleration at which a collision prevention distance set to prevent collision between the vehicle and the leading vehicle is maintained.

In embodiments, if the danger level of the leading vehicle or the nearby vehicle is less than the setting value, the target acceleration determination unit 230 determines the target acceleration to match the automatic driving speed in a situation in which a difference in speed between the nearby vehicle and the vehicle is not big and determines the target acceleration to maintain a relative distance between the leading vehicle and the vehicle. Therefore, the feeling of discomfort of a driver according to vertical-direction acceleration automatic control of the vehicle is minimized and a traffic flow is optimized.

The target acceleration determination unit 230 transmits the determined target acceleration to the vehicle control unit 300.

The vehicle control unit 300 receives the target acceleration from the target acceleration determination unit 230.

The vehicle control unit 300 controls the vehicle to drive at the automatic driving speed input by the driver and controls the vehicle according to the target acceleration upon sensing the leading vehicle or the nearby vehicle.

In embodiments, when there are no other vehicles around the vehicle, the vehicle control unit 300 controls the vehicle to automatically drive at the automatic driving speed. The automatic driving speed may be randomly set by a user and may be changed during driving.

The vehicle control unit 300 controls the vehicle to move according to the target acceleration. To this end, the vehicle control unit 300 controls a driving means and a braking means of the vehicle. In embodiments, the vehicle control unit 300 accelerates or decelerates the vehicle according to the target acceleration.

The apparatus for controlling automatic driving of a vehicle according to embodiments of the present invention can obtain stable ride comfort by controlling acceleration of the vehicle.

The apparatus for controlling automatic driving of a vehicle according to embodiments of the present invention may further include a display unit. The display unit may be a dashboard or a vehicle navigation system. The display unit outputs a map image displaying the leading vehicle or the nearby vehicle sensed by the vehicle sensing unit 100 and displays the speed and the relative distance with respect to the leading vehicle or the nearby vehicle. The display unit may also display a current speed and target acceleration of the vehicle and the danger level and setting speed of the leading vehicle or the nearby vehicle.

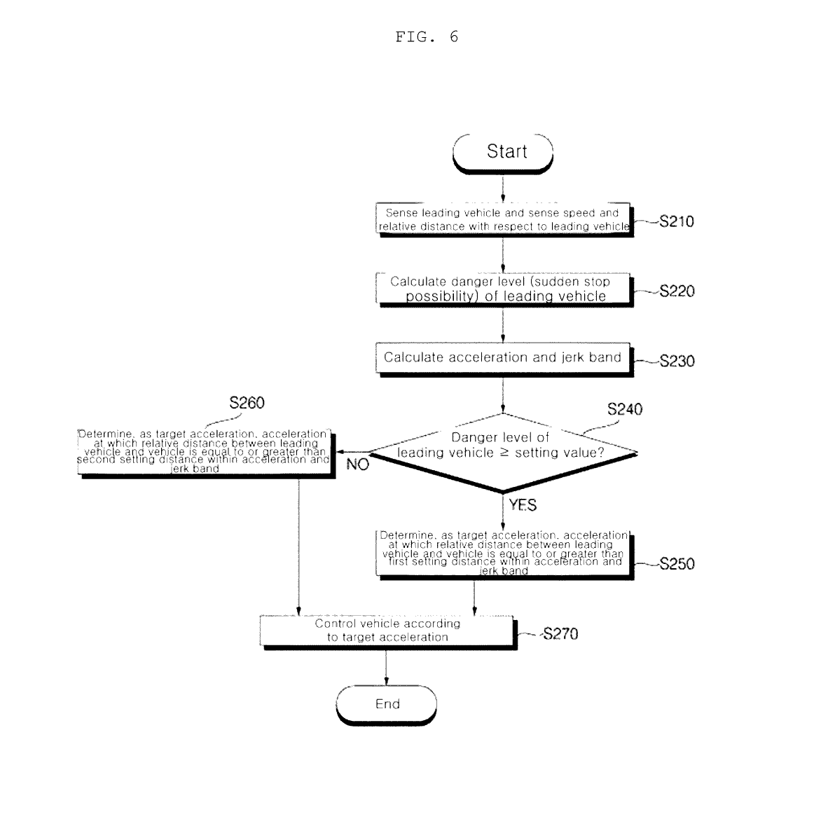

FIG. 5 is a flowchart illustrating a method of controlling automatic driving of a vehicle according to embodiments of the present invention.

The method of controlling automatic driving of a vehicle according to embodiments of the present invention includes performing constant speed driving (S110) for controlling driving of a vehicle at an automatic driving speed input by a driver, performing leading or nearby vehicle sensing (S120) for sensing a leading vehicle that drives in front of the vehicle in a driving lane of the vehicle or a nearby vehicle that drives at a right or left lane of the driving lane of the vehicle, performing vehicle sensing (S130) for sensing a speed of the leading vehicle and a relative distance from the vehicle to the leading vehicle or a speed of the nearby vehicle and a relative distance from the vehicle to the nearby vehicle, performing target acceleration calculation (S140) for calculating a danger level indicating an influence on driving of the vehicle by the leading vehicle or the nearby vehicle using the sensed speed and relative distance and calculating a target acceleration of the vehicle in correspondence to the danger level, and performing vehicle control (S150) for controlling the vehicle according to target acceleration upon sensing the leading vehicle or the nearby vehicle.

In performing the constant speed driving (S110), the vehicle control unit 300 controls driving of the vehicle at an automatic driving speed input by a driver.

In performing the leading or nearby vehicle sensing (S120), the vehicle sensing unit 100 senses the leading vehicle which drives in front of the vehicle in the driving lane of the vehicle or the nearby vehicle which drives at a left or right lane of the driving lane of the vehicle. If the leading vehicle or the nearby vehicle is not sensed, the vehicle control unit 300 continues to perform the constant speed driving (S110).

Upon sensing the leading vehicle or the nearby vehicle, the vehicle sensing unit 100 senses the speed of the leading vehicle or the nearby vehicle and the relative distance between the vehicle and the leading vehicle or the nearby vehicle (S130). The vehicle sensing unit 100 transmits the speed of the leading vehicle or the nearby vehicle and the relative distance between the vehicle and the leading vehicle or the nearby vehicle to the target acceleration calculation unit 200.

In performing the target acceleration calculation (S140), the target acceleration calculation unit 200 calculates the target acceleration of the vehicle using the speed and the relative distance with respect to the leading vehicle or the nearby vehicle received from the vehicle sensing unit 100. The target acceleration calculation unit 200 transmits the target acceleration to the vehicle control unit 300.

In performing the vehicle control (S150), the vehicle control unit 300 controls the vehicle according to the target acceleration received from the target acceleration calculation unit 200. Therefore, the vehicle moves according to the target acceleration.

The performing the target acceleration calculation (S140) includes performing danger level calculation for calculating a danger level of the leading vehicle or the nearby vehicle indicating an influence on driving of the vehicle by the leading vehicle or the nearby vehicle using the speed and the relative distance with respect to the leading vehicle or the nearby vehicle, performing band calculation for calculating an acceleration of the leading vehicle or the nearby vehicle and a jerk indicating an instantaneous rate of change of the acceleration using the speed and the relative distance with respect to the leading vehicle or the nearby vehicle and calculating an acceleration and a jerk band indicating a range within which the target acceleration is selected according to the calculated acceleration and jerk, and performing target acceleration determination for determining the target acceleration within the band according to the danger level of the leading vehicle or the nearby vehicle.

In performing the danger level calculation, the leading vehicle danger level calculation unit 211 calculates an expected TTC using the speed and the relative distance with respect to the leading vehicle and the speed of the vehicle, received from the leading vehicle sensing unit 110, determines an expected acceleration of the leading vehicle by recognizing a speed variation pattern of the leading vehicle, and calculates the danger level of the leading vehicle by adding a value obtained by multiplying a first weight by the expected acceleration to a value obtained by multiplying a second weight by the TTC. The leading vehicle danger level calculation unit 211 transmits the danger level of the leading vehicle to the target acceleration determination unit 230.

In addition, in performing the danger level calculation, the nearby vehicle danger level calculation unit 212 calculates a speed at which the nearby vehicle approaches the driving lane of the vehicle, a speed at which the nearby vehicle approaches the vehicle, and a distance between the nearby vehicle and the driving lane of the vehicle, using the speed and the relative distance with respect to the nearby vehicle, received from the nearby vehicle sensing unit 120, calculates a probability of intercepting the driving lane of the vehicle by the nearby vehicle according to the calculated speeds and distance, and then calculates the danger level of the nearby vehicle corresponding to the interception possibility. The nearby vehicle danger level calculation unit 212 transmits the danger level of the nearby vehicle to the target acceleration determination unit 230.

In performing the band calculation, the band calculation unit 220 calculates the acceleration and jerk (an instantaneous rate of change of the acceleration) of the leading vehicle or the nearby vehicle using the speed and the relative distance with respect to the leading vehicle or the nearby vehicle, received from the vehicle sensing unit 100, and calculates the acceleration and jerk band indicating a band within which the target acceleration is selected according to the calculated acceleration and jerk. The band calculation unit 220 transmits the acceleration and jerk band to the target acceleration determination unit 230.

Alternatively, the performing the band calculation may precede the performing the danger level calculation or the two operations may be simultaneously performed.

The target acceleration determination unit 230 receives the danger level of the leading vehicle or the nearby vehicle from the danger level calculation unit 210 and receives the acceleration and jerk band from the band calculation unit 220.

In performing the target acceleration determination, the target acceleration determination unit 230 receives the danger level of the leading vehicle or nearby vehicle from the danger level calculation unit 210, receives the acceleration and jerk band from the band calculation unit 220, and then determines, as the target acceleration, an acceleration at which a relative distance between the leading vehicle or the nearby vehicle having a danger level equal to or greater than a setting value and the vehicle is equal to or greater than a first setting distance within the acceleration and jerk band

If the danger level of the leading vehicle is less than the setting value, the performing the target acceleration determination includes determining, as the target acceleration, an acceleration at which a relative distance between the leading vehicle and the vehicle is equal to or greater than a second setting distance within the acceleration and jerk band.

If the danger level of the nearby vehicle is less than the setting value, the performing the target acceleration determination includes determining, as the target acceleration, an acceleration at which the vehicle drives at an automatic driving speed input by a driver within the acceleration and jerk band.

Hereinafter, an embodiment of the vehicle automatic driving control method according to embodiments of the present invention will be described with respect to the case in which the leading vehicle is sensed and the case in which the nearby vehicle is sensed.

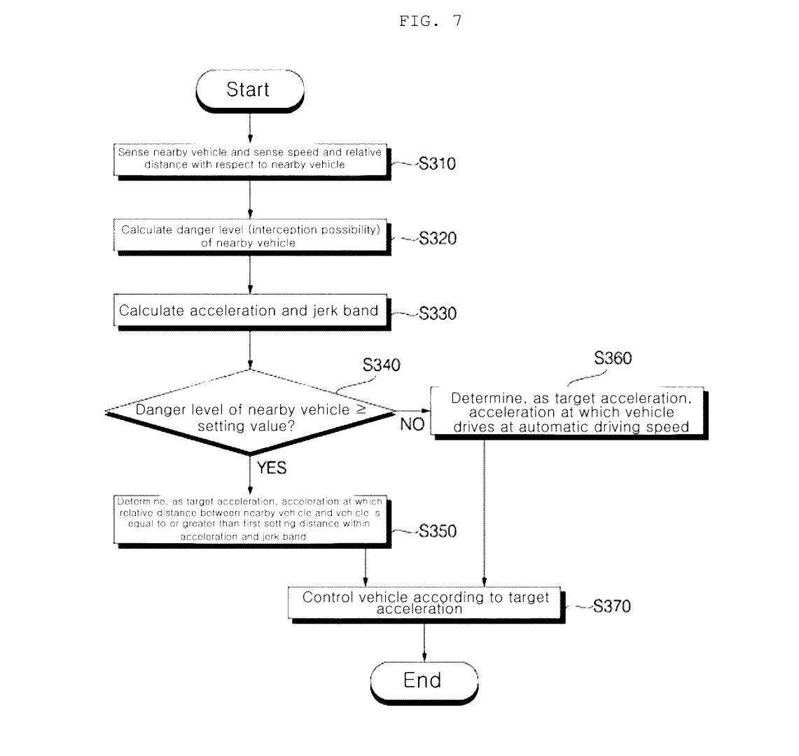

FIG. 6 is a flowchart illustrating target acceleration calculation upon sensing a leading vehicle as an embodiment of the method of controlling automatic driving of a vehicle according to embodiments of the present invention.

The leading vehicle sensing unit 110 senses the leading vehicle and senses a speed of the leading vehicle and a relative distance to the leading vehicle (S210). The leading vehicle sensing unit 110 transmits the speed and the relative distance with respect to the leading vehicle to the leading vehicle danger level calculation unit 211 and the band calculation unit 220.

The leading vehicle danger level calculation unit 211 receives the speed and the relative distance with respect to the leading vehicle from the leading vehicle sensing unit 110 and calculates a danger level of the leading vehicle (S220). The leading vehicle danger level calculation unit 211 calculates an expected TTC using the speed of the vehicle and the speed and the relative distance with respect to the leading vehicle, determines an expected acceleration of the leading vehicle by recognizing a speed variation pattern of the leading vehicle, and calculates a danger level of the leading vehicle by adding a value obtained by multiplying a first weight by the expected acceleration to a value obtained by multiplying a second weight by the TTC. The leading vehicle danger level calculation unit 211 transmits the danger level of the leading vehicle to the target acceleration determination unit 230.

The band calculation unit 220 calculates an acceleration and jerk band using the speed and the relative distance with respect to the leading vehicle, received from the leading vehicle sensing unit 110 (S230). The band calculation unit 220 calculates an acceleration and a jerk (an instantaneous rate of change of the acceleration) of the leading vehicle using the speed and the relative distance with respect to the leading vehicle and calculates the acceleration and jerk band indicating a range within which a target acceleration is selected according to the calculated acceleration and jerk. The band calculation unit 220 transmits the acceleration and jerk band to the target acceleration determination unit 230.

Steps S220 and S230 are changeable in order.

The target acceleration determination unit 230 determines whether the danger level of the leading vehicle received from the leading vehicle danger level calculation unit 211 is equal to or greater than a setting value (S240). If the danger level of the leading vehicle is equal to or greater than the setting value, the target acceleration determination unit 230 determines, as the target acceleration, an acceleration at which a relative distance between the leading vehicle and the vehicle is equal to or greater than a first setting distance within the acceleration and jerk band (S250).

The setting value indicates a state having a great influence on driving of the vehicle by the leading vehicle, in embodiments, a high danger level of the leading vehicle because there is a high possibility that the leading vehicle suddenly stops and may be randomly set by a user. The first setting distance is a distance set to prevent collision between the vehicle and the leading vehicle and may be randomly set by a user.

If the danger level of the leading vehicle is less than the setting value, the target acceleration determination unit 230 determines, as the target acceleration, an acceleration at which the relative distance between the leading vehicle and the vehicle is equal to or greater than a second setting distance within the acceleration and jerk band (S260).

If there is a low possibility that the leading vehicle suddenly stops, the second setting distance indicates a general relative distance between the vehicle and the leading vehicle and may be randomly set by a user.

The target acceleration determination unit 230 transmits the target acceleration to the vehicle control unit 300.

The vehicle control unit 300 controls the vehicle according to the target acceleration received from the target acceleration determination unit 230 (S270).

FIG. 7 is a flowchart illustrating target acceleration calculation upon sensing a nearby vehicle as an embodiment of the method of controlling automatic driving of a vehicle according to embodiments of the present invention.

The nearby vehicle sensing unit 120 senses the nearby vehicle and senses a speed of the nearby vehicle and a relative distance to the nearby vehicle (S310). The nearby vehicle sensing unit 120 transmits the speed and the relative distance with respect to the nearby vehicle to the nearby vehicle danger level calculation unit 212 and the band calculation unit 220.

The nearby vehicle danger level calculation unit 212 receives the speed and the relative distance with respect to the nearby vehicle from the nearby vehicle sensing unit 120 and calculates a danger level of the nearby vehicle (S320). The nearby vehicle danger level calculation unit 212 calculates a speed at which the nearby vehicle approaches a driving lane of the vehicle, a speed at which the nearby vehicle approaches the vehicle, and a distance between the nearby vehicle and the driving lane of the vehicle, using the speed and the relative distance with respect to the nearby vehicle, calculates a probability of intercepting the driving lane of the vehicle by the nearby vehicle according to the calculated speeds and distance, and then calculates the danger level of the nearby vehicle corresponding to the interception possibility. The nearby vehicle danger level calculation unit 212 transmits the danger level of the nearby vehicle to the target acceleration determination unit 230.

The band calculation unit 220 calculates an acceleration and jerk band using the speed and the relative distance with respect to the nearby vehicle, received from the nearby vehicle sensing unit 120 (S330). The band calculation unit 220 calculates an acceleration and a jerk (an instantaneous rate of change of the acceleration) of the nearby vehicle using the speed and the relative distance with respect to the nearby vehicle and calculates the acceleration and jerk band indicating a range within which a target acceleration is selected according to the calculated acceleration and jerk. The band calculation unit 220 transmits the acceleration and jerk band to the target acceleration determination unit 230.

Steps S320 and S330 are changeable in order.

The target acceleration determination unit 230 determines whether the danger level of the nearby vehicle received from the nearby vehicle danger level calculation unit 212 is equal to or greater than a setting value (S340). If the danger level of the nearby vehicle is equal to or greater than the setting value, the target acceleration determination unit 230 determines, as the target acceleration, an acceleration at which a relative distance between the nearby vehicle and the vehicle is equal to or greater than a first setting distance within the acceleration and jerk band (S350).

The setting value indicates a state having a great influence on driving of the vehicle by the nearby vehicle, in embodiments, a high danger level of the nearby vehicle because there is a high possibility that the nearby vehicle intercepts the driving lane of the vehicle and may be randomly set by a user. The first setting distance is a distance set to prevent collision between the vehicle and the nearby vehicle and may be randomly set by a user.

If the danger level of the nearby vehicle is less than the setting value, the target acceleration determination unit 230 determines, as the target acceleration, an acceleration at which the vehicle drives at an automatic driving speed input by a driver within the acceleration and jerk band (S360).

In embodiments, if the danger level of the nearby vehicle is less than the setting value, this means that there is a low possibility that the nearby vehicle intercepts the driving lane of the vehicle, the vehicle drives at the automatic driving speed input by a driver. However, since change of the speed of the vehicle to the automatic driving speed may cause deterioration of ride comfort and safety due to an abrupt speed change, an acceleration at which the vehicle drives at the automatic driving speed within the acceleration and jerk band is determined as the target acceleration. The vehicle control unit 300 controls the vehicle according to the target acceleration received from the target acceleration determination unit 230 (S370) Therefore, safety of the vehicle is improved because a difference in speed or acceleration with the nearby vehicle is not big and ride comfort is more improved relative to speed control because the vehicle is controlled through acceleration variation. In addition, stable ride comfort can be improved even while the vehicle is decelerated as well as while the vehicle is accelerated. The apparatus and method of controlling automatic driving of a vehicle according to embodiments of the present invention have one or more effects as follows.

First, safety is improved by reflecting a danger possibility caused by a leading vehicle and a nearby vehicle during automatic driving of a vehicle.

Second, a traffic flow is smoothed and safety is improved by reflecting a nearby traffic flow and controlling automatic driving of a vehicle.

The effects of the present invention should not be limited to the aforementioned effects and other not-mentioned effects will be clearly understood by those skilled in the art from the claims.

Embodiments of the present invention have been illustrated and described above, but the present invention is not limited to the above-described embodiments, it is obvious that various modifications may be made by those skilled in the art, to which the present invention pertains without departing from the gist of the present invention as claimed, and such modifications should not be individually understood from the technical spirit or prospect of the present invention.

What is claimed is:

1. An apparatus for controlling automatic driving of a vehicle, the apparatus comprising at least one processor, the processor performing:
sensing a leading vehicle driving in front of the vehicle in a driving lane of the vehicle or a nearby vehicle driving at a left or right lane of the driving lane of the vehicle and sensing a speed of the leading vehicle and a relative distance from the vehicle to the leading vehicle or a speed of the nearby vehicle and a relative distance from the vehicle to the nearby vehicle;
calculating a danger level indicating an influence on driving of the vehicle of the leading vehicle or the nearby vehicle using the sensed speed and relative distance and calculating a target acceleration of the vehicle according to the danger level; and
controlling the vehicle to drive at an automatic driving speed and controlling the vehicle according to the target acceleration upon sensing the leading vehicle or the nearby vehicle.

2. The apparatus according to claim 1, wherein the vehicle sensing includes:
sensing the speed and the relative distance with respect to the leading vehicle; and
sensing the speed and the relative distance with respect to the nearby vehicle.

3. The apparatus according to claim 1, wherein the calculating includes:
calculating the danger level indicating an influence on driving of the vehicle by the leading vehicle or the nearby vehicle using the speed and the relative distance with respect to the leading vehicle or the nearby vehicle;
calculating an acceleration of the leading vehicle or the nearby vehicle and a jerk indicating an instantaneous rate of change of the acceleration using the speed and the relative distance with respect to the leading vehicle or the nearby vehicle and calculating an acceleration and jerk band indicating a range within which the target acceleration is selected according to the calculated acceleration and the calculated jerk; and
determining the target acceleration within the band according to the danger level of the leading vehicle or the nearby vehicle.

4. The apparatus according to claim 3, wherein the danger level calculating includes:
calculating an expected time to collision (TTC) using the speed of the vehicle, the speed of the leading vehicle, and the relative distance between the vehicle and the leading vehicle, determining an expected acceleration of the leading vehicle by recognizing a speed variation pattern of the leading vehicle, and calculating the danger level of the leading vehicle by adding a value obtained by multiplying a first weight by the expected acceleration to a value obtained by multiplying a second weight by the TTC; and
calculating a speed at which the nearby vehicle approaches the driving lane of the vehicle using the speed and the relative distance with respect to the nearby vehicle, a speed at which the nearby vehicle approaches the vehicle, and a distance between the nearby vehicle and the driving lane of the vehicle, calculating a possibility of intercepting the driving lane of the vehicle by the nearby vehicle according to the calculated speeds and the calculated distance, and calculating the danger level of the nearby vehicle corresponding to the interception possibility.

5. The apparatus according to claim 3, wherein the determining, as the target acceleration, an acceleration at which a relative distance between the leading vehicle or the nearby vehicle having a danger level exceeding a setting value and the vehicle is equal to or greater than a first set distance within the acceleration and jerk band.

6. The apparatus according to claim 3, wherein, if the danger level of the leading vehicle is less than the setting value, determining, as the target acceleration, an acceleration at which a relative distance between the leading vehicle and the vehicle is greater than a second setting distance within the acceleration and jerk band.

7. The apparatus according to claim 3, wherein, if the danger level of the nearby vehicle is less than the setting value, determining, as the target acceleration, an acceleration at which the vehicle drives at an automatic driving speed within the acceleration and jerk band.

8. A method of controlling automatic driving a vehicle, the method comprising:
performing constant speed driving for controlling driving of the vehicle at an automatic driving speed;
performing vehicle sensing for sensing a leading vehicle driving in front of the vehicle in a driving lane of the vehicle or a nearby vehicle driving at a right or left lane of the driving lane of the vehicle and sensing a speed of the leading vehicle and a relative distance from the vehicle to the leading vehicle or a speed of the nearby vehicle and a relative distance from the vehicle to the nearby vehicle;
performing target acceleration calculation for calculating a danger level indicating an influence on driving of the vehicle by the leading vehicle or the nearby vehicle using the sensed speed and relative distance and calculating a target acceleration of the vehicle in correspondence to the danger level; and performing vehicle control for controlling the vehicle according to target acceleration upon sensing the leading vehicle or the nearby vehicle.

9. The method according to claim 8, wherein the performing the target acceleration calculation includes:
performing danger level calculation for calculating a danger level of the leading vehicle or the nearby vehicle indicating an influence on driving of the vehicle by the leading vehicle or the nearby vehicle using the speed and the relative distance with respect to the leading vehicle or the nearby vehicle;
performing band calculation for calculating an acceleration of the leading vehicle or the nearby vehicle and a jerk indicating an instantaneous rate of change of the acceleration using the speed and the relative distance with respect to the leading vehicle or the nearby vehicle and calculating an acceleration and a jerk band indicating a range within which the target acceleration is selected according to the calculated acceleration and jerk; and
performing target acceleration determination for determining the target acceleration within the band according to the danger level of the leading vehicle or the nearby vehicle.

10. The method according to claim 9, wherein the performing the danger level calculation includes:
calculating an expected time to collision (TTC) using the speed of the vehicle and the speed and the relative distance with respect to the leading vehicle, determining an expected acceleration of the leading vehicle by recognizing a speed variation pattern of the leading vehicle, and calculating the danger level of the leading vehicle by adding a value obtained by multiplying a first weight by the expected acceleration to a value obtained by multiplying a second weight by the TTC; and
calculating a speed at which the nearby vehicle approaches the driving lane of the vehicle, a speed at which the nearby vehicle approaches the vehicle, and a distance between the nearby vehicle and the driving lane of the vehicle, using the speed and the relative distance with respect to the nearby vehicle, calculating a probability of intercepting the driving lane of the vehicle by the nearby vehicle according to the calculated speeds and distance, and then calculates the danger level of the nearby vehicle corresponding to the interception possibility.

11. The method according to claim 9, wherein the performing the target acceleration determination includes determining, as the target acceleration, an acceleration at which a relative distance between the leading vehicle or the nearby vehicle having a danger level equal to or greater than a setting value and the vehicle is equal to or greater than a first setting distance within the acceleration and jerk band.

12. The method according to claim 9, wherein, if the danger level of the leading vehicle is less than the setting value, the performing the target acceleration determination includes determining, as the target acceleration, an acceleration at which a relative distance between the leading vehicle and the vehicle is equal to or greater than a second setting distance within the acceleration and jerk band.

13. The method according to claim 9, wherein, if the danger level of the nearby vehicle is less than the setting value, the performing the target acceleration determination includes determining, as the target acceleration, an acceleration at which the vehicle drives at an automatic driving speed input by a driver within the acceleration and jerk band.

14. A method of cruise control of a vehicle, the method comprising:
detecting nearby vehicles comprising at least one vehicle driving ahead or behind of the vehicle on the same lane, the right lane and the left lane;
acquiring data for each nearby vehicle indicative of a distance to the nearby vehicle, a speed of the nearby vehicle, acceleration of the nearby vehicle and jerk of the nearby vehicle;
assessing probability of accidents with each nearby vehicle;
identifying the most risky one of the nearby vehicles;
computing a range of acceleration that the vehicle can have while driving under cruise control in view of the acquired data for the nearby vehicles; and
determining an acceleration value within the range while driving under cruise control in view of the distance to and speed of the most risky nearby vehicle.

15. The method of claim 14, further comprising:
identifying the second most risky nearby vehicle among the nearby vehicles; and
determining the acceleration value within the range in view of the distance to and speed of the most risky nearby vehicle and further in view of the distance and speed of the second most risky nearby vehicle.
